(19) United States
(12) Patent Application Publication
(10) Pub. No.: US 2026/0091738 A1
(43) Pub. Date: Apr. 2, 2026

(54) CARGO CONTAINER

(71) Applicant: Kuat Innovations LLC, Springfield, MO (US)

(72) Inventors: Luke Kuschmeader, Springfield, MO (US); Jamie Kummerfeld, Greeley, CO (US); Jim Quintus, Nixa, MO (US); Jordan Bowles, Lexington, SC (US)

(21) Appl. No.: 19/410,586

(22) Filed: Dec. 5, 2025

Related U.S. Application Data
(63) Continuation of application No. 18/337,718, filed on Jun. 20, 2023.
(60) Provisional application No. 63/353,741, filed on Jun. 20, 2022.

(51) Int. Cl. B60R 9/055; B60R 9/045

(52) U.S. Cl. CPC B60R 9/055; B60R 9/045

(57) ABSTRACT

A cargo container for a vehicle roof has dual latch handles, with one latch handle on each side of the cargo container. The cargo container comprises a lid that may be in closed or open configurations. In the closed configuration, the latch handles may be in a locked or unlocked state. In the unlocked state the latches may be latched or unlatched. The cargo container may be reconfigured from closed to open configurations when either of the latches is in the unlocked and unlatched state, even if the other latch is in the locked state or the unlocked, latched state. This allows a user to open the cargo container without walking around to both sides of a vehicle to unlock both latches. The cargo container utilizes a single hinge axis between the lid and the base of the cargo container and does not need multiple, disconnecting hinges.

### CROSS-REFERENCE TO RELATED APPLICATIONS

This application is a continuation of U.S. patent application Ser. No. 18/337,718, filed on Jun. 20, 2023, and claims the benefit thereof, including its claim for the benefit of the filing date of U.S. Provisional Patent Application Ser. No. 63/353,741 filed on Jun. 20, 2022.

### BACKGROUND

### Field of the Invention

This disclosure is in the field of cargo containers for use on the roof of automobiles, on trucks, trailers, vans, or other vehicles. More specifically, this disclosure is in the field of latch systems and assemblies for cargo containers.

### SUMMARY OF THE INVENTION

In some embodiments the cargo container has at least two latch handles, with one latch handle on each side of the cargo container. The cargo container comprises a lid that may be in closed or open configurations. In the closed configuration, the latch handles may be in a locked or unlocked state. In the unlocked state the latches may be latched or unlatched. The cargo container may be reconfigured from closed to open configurations when either of the latches is in the unlocked and unlatched state, even if the other latch is in the locked state or the unlocked, latched state. This allows a user to open the cargo container without walking around to both sides of a vehicle to unlock both latches. The cargo container does not require a dual hinge system to function in the described manner.

### BRIEF DESCRIPTION OF THE DRAWINGS

FIG. 1A is a perspective view of an embodiment of the cargo container in a closed configuration with the latch mechanism in a latched state.

FIG. 1B is a perspective view of an embodiment of the cargo container in a closed configuration with the latch mechanism in an unlatched state.

FIG. 1C is a perspective view of an embodiment of the cargo container in an open configuration.

FIG. 2A is a perspective view of an embodiment of the latch mechanism of the cargo container in a latched state with the shell of the cargo container removed for clarity.

FIG. 2B is a perspective view of an embodiment of the latch mechanism of the cargo container in an unlatched state with the shell of the cargo container removed for clarity.

FIG. 3A is a detail perspective view of a portion of an embodiment of the latch mechanism of the cargo container in a latched state.

FIG. 3B is a detail perspective view of a portion of an embodiment of the latch mechanism of the cargo container in an unlatched state.

FIG. 4A is a side cross-sectional view of an embodiment of the latch mechanism of the cargo container in a latched state on axis 4A-4A shown on FIG. 5A.

FIG. 4B is a side cross-sectional view of an embodiment of the latch mechanism of the cargo container in an unlatched state on axis 4B-4B shown on FIG. 5B.

FIG. 5A is a top cross-sectional view of an embodiment of the latch mechanism of the cargo container in a latched state on axis 5-5 shown on FIG. 4A.

FIG. 5B is a top cross-sectional view of an embodiment of the latch mechanism of the cargo container in an unlatched state on axis 5-5 shown on FIG. 4A.

FIG. 6A is a top plan view of an embodiment of the latch mechanism of the cargo container in a latched state.

FIG. 6B is a top plan view of an embodiment of the latch mechanism of the cargo container in an unlatched state.

FIG. 7A is a detail perspective view of a portion of an embodiment of the latch mechanism of the cargo container in a latched state.

FIG. 7B is a detail perspective view of a portion of an embodiment of the latch mechanism of the cargo container in an unlatched state.

FIG. 8 is a top perspective of a portion of an embodiment of the latch mechanism with some components removed for clarity.

FIG. 9 is a side view of a portion of an embodiment of the latch mechanism with some components all or partially removed for clarity.

### DETAILED DESCRIPTION

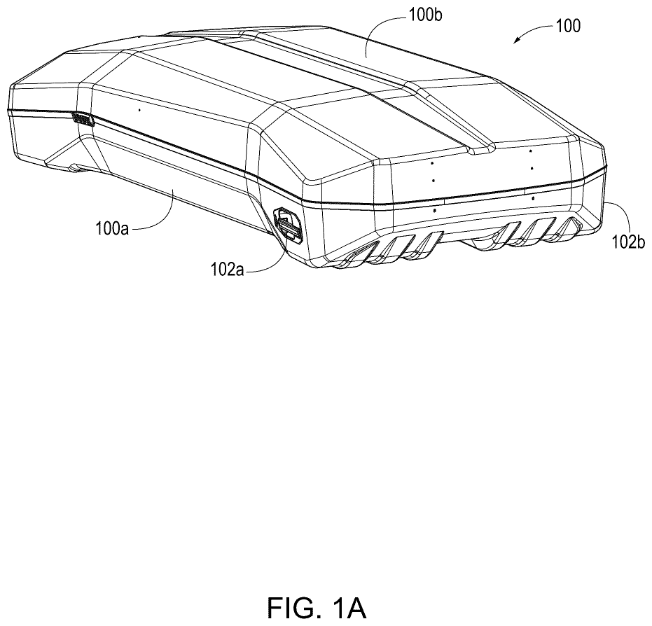

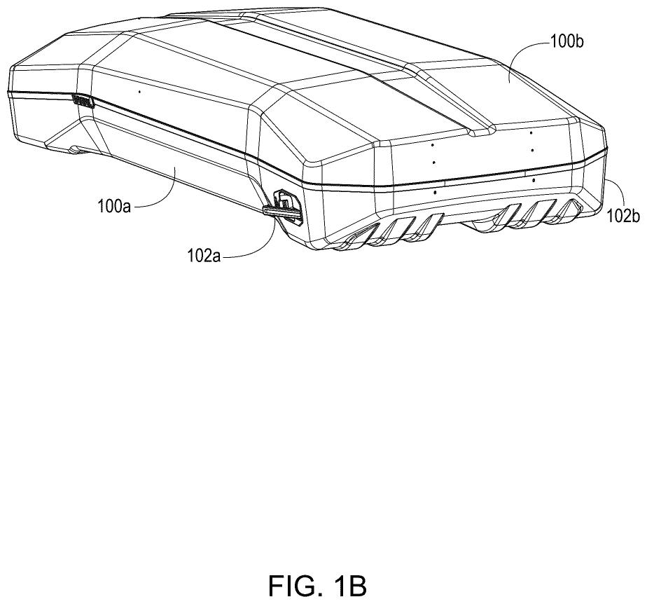

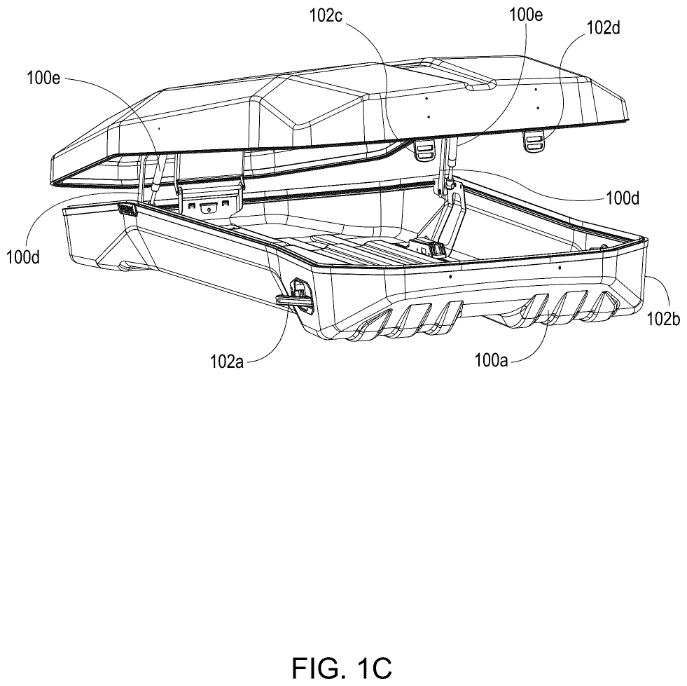

Referring now to FIGS. 1A, 1B, and 1C, perspective views of a cargo container are depicted with an embodiment of the inventive latch mechanism in a latched state, an unlatched state, and an open state, respectively. Cargo containers such as cargo container 100 are often attached to the outside of automobiles, trucks, vans, recreational vehicles, and other motor vehicles to provide additional storage space for various items. The cargo containers are often formed of two rigid or semi-rigid components that coordinate together to form a substantially enclosed space to store the items. In the depicted embodiment the cargo container is formed from a bottom shell or member 100a and a top shell or member 100b. The top and bottom shells may be provided with a means to open and close them such as hinges 100c, support arms 100d, and biasing mechanisms 100e. The biasing mechanisms 100e may comprise gas or spring struts to reduce the force necessary to raise the top shell 100b. Support arms 100d may be provided to hold the lid in the open configuration.

The cargo container 100 depicted in the figures is provided with an embodiment of the inventive latch mechanism. In this embodiment, two latch actuators 102a and 102b are disposed on the outer surface of the bottom shell 100a, though in other embodiments the actuators may be positioned on the top shell 100b. In operation a user may pull on the actuator 102a to pivot it from the latched position shown in FIG. 1A to the unlatched position shown in FIG. 1B. In other embodiments the actuator 102a may translate outwardly, inwardly, or along the surface of the cargo container 100, instead of pivoting with respect to it. In some embodiments the actuator 102a may pivot upwardly, downwardly, or toward the front of the cargo container 100, instead of the depicted embodiment which pivots toward the rear end of the cargo container. In some embodiments the actuators 102a and 102b may move in rotation instead of translation or pivotal movement.

When the user moves the actuator to the unlatched position or state, the latch mechanism disengages, and the user may raise the top shell 100b upwardly to open the cargo container 100 as shown in FIG. 1C. In this configuration items may be placed into or removed from the cargo container. A user may unlock each actuator 102a or 102b independently and open the cargo container even if the actuator on the other side of the cargo container is locked or latched in the closed position.

In some cargo containers that may be opened from either side a user may have to lock the actuators on both sides of a cargo container to render it safe for use on a motor vehicle. In the inventive latch mechanism, it is possible to safely leave the latch mechanism unlocked during use of the cargo container 100 on a moving vehicle. Then when a user desires to open the cargo box only one actuator must be operated to open the lid. The other actuator may remain locked or unlocked without effect on the actuator used to open the container. This functionality results in easier operational use by a person accessing the cargo container since they may leave the actuators unlocked during movement of the vehicle.

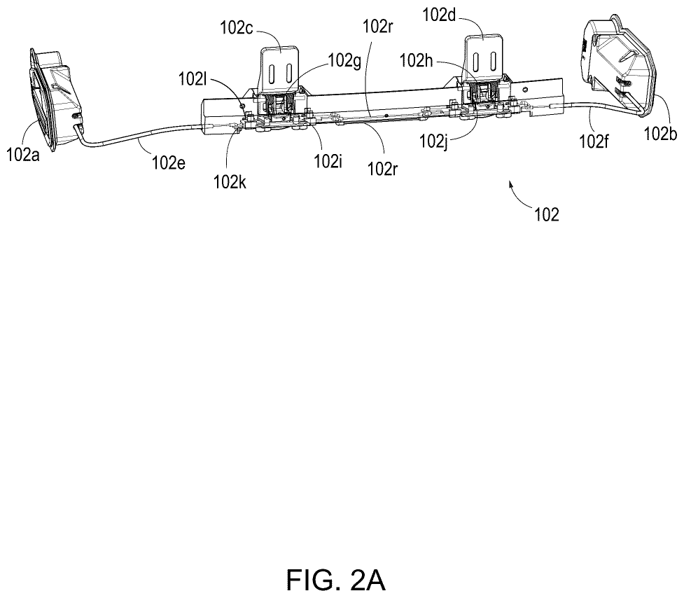

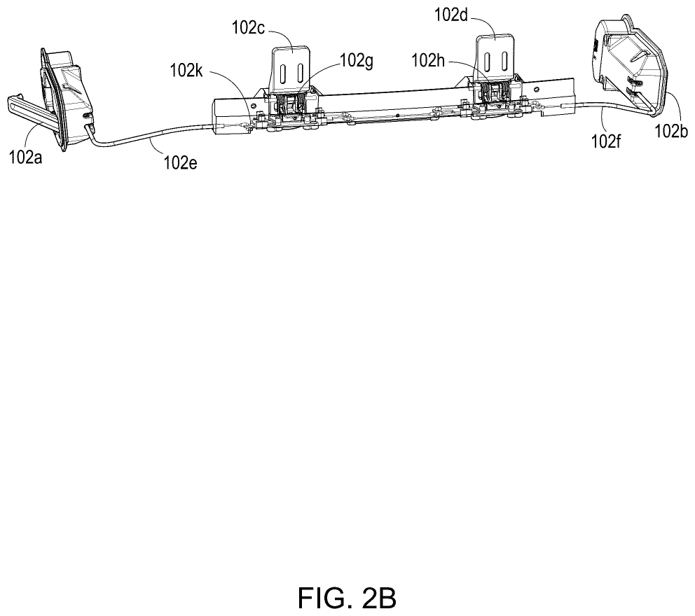

FIGS. 2A and 2B depict an embodiment of the inventive latch mechanism 102 with the top and bottom shells 100a and 100b of the cargo container 100 (and other parts) removed for unobstructed viewing of the internal components. The first (or left) and second (or right) latch actuators 102a and 102b respectively are mounted in housings, cavities, or apertures that are incorporated into the shell of the cargo container 100. The actuators may have a lock core incorporated into the actuator, or its housing, cavity, or aperture, to selectively prevent its movement when a user engages the lock. Specific components and mechanisms for the lock mechanism are known to those of skilled in mechanical arts. In the depicted embodiment the movement of the actuator 102a or 102b pulls on first (or left) and second (or right) actuator cables 102e and 102f, respectively. In this disclosure, the latch mechanism has mirror components that will be referred to as “first” or “left” and “second” or “right”. The terms left and right are with respect to a person sitting in a car on which the cargo container 100 has been installed for use.

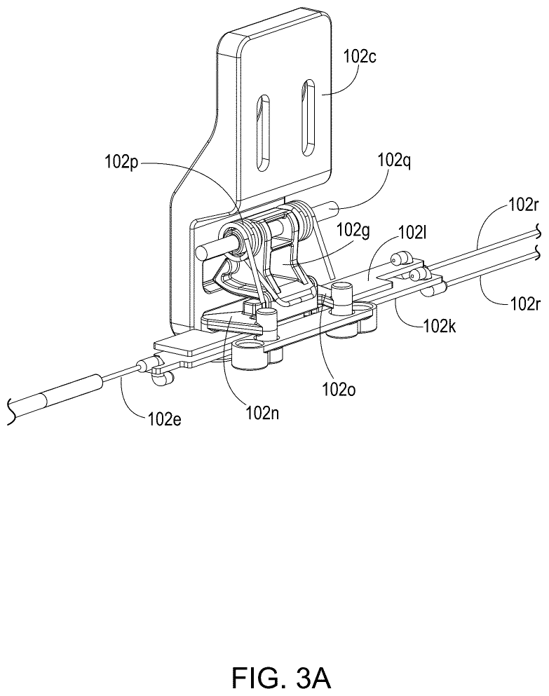

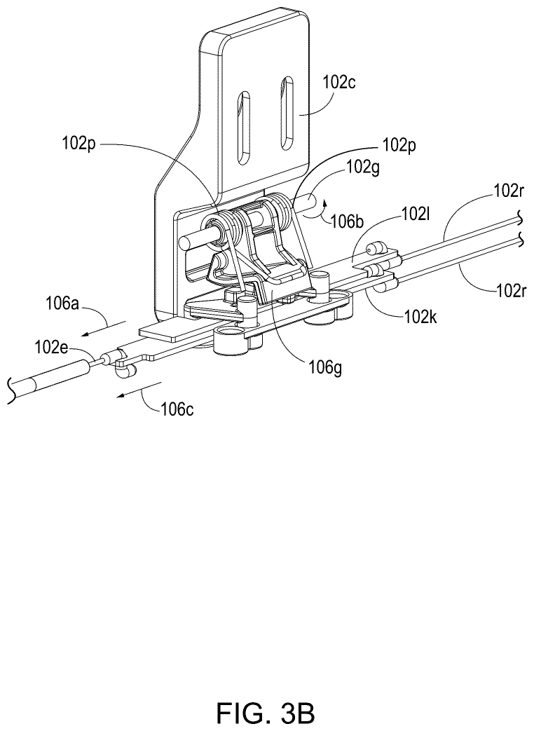

Referring generally to FIGS. 3A through 8, various views of an embodiment of the inventive latch mechanism are depicted. In the depicted embodiment the latch mechanism 102 engages left and right strike plates 102c and 102d, respectively, to hold the top and bottom shells in the closed configuration. In this embodiment the strike plates 102c and 102d are attached to the top shell 100b of the cargo container 100 as can be seen in FIG. 1C, although in some embodiments the arrangement may be reversed with the strike plates 102c and 102d attached to the bottom shell 100a. In some embodiments the latch mechanism 102 may only have one strike plate or may have more than two. The strike plates may have apertures, ridges, cavities, or other features designed to receive or engage the latch bolt described later in this disclosure. In FIGS. 2A and 2B the strike plates are shown inserted into the latch mechanism to engage the latch bolt or pawl.

In the depicted embodiment, latch strike plate 102c or 102d is engaged by the left or right latch bolts or pawls 102g and 102h, respectively. The latch bolts 102g and 102h are movably attached to the cargo container 100 by a bracket or housing that allows the latch bolt to move sufficiently to engage and disengage from the strike plate. In the depicted embodiment the latch bolts pivot on a pivot pin 102q to move partially into an aperture provided in the strike plate. In this embodiment the latch bolts 102g and 102h are actuated by a first and second actuator bar 102k and 102l, respectively, that, in turn, move in response to the user's movement of one of the latch actuators 102a or 102b. In some embodiments the first and second actuator bars may be provided with a biasing mechanism 102p such as a spring to apply a biasing force to the bars to return them to the latched position.

In the depicted embodiment, movement of the actuator 102a from the latched position in FIGS. 2A, 3A, 4A, and 5A to the unlatched position of FIGS. 2B, 3B, 4B, and 5B causes first/left actuator cable 102e to translate toward the actuator 102a. A first end of cable 102e is connected to the actuator 102a so that the pivotal movement of the actuator 102a pulls the cable 102e. In this embodiment, the second end of cable 102e is connected to first actuator bar 102k, so that movement of the cable 102e causes bar 102k to translate towards actuator 102a as shown in FIG. 2B. The movement of the latch bar 102k is also depicted in FIGS. 3A and 3B which show a detailed view of portions of the latch mechanism 102. When the cable 102e is pulled in the direction of arrow 106c this causes actuator bar 102k to move in the direction of arrow 106a.

As will be described in more detail below, the movement of actuator bar 102k causes latch bolt 102g to pivot around pin 102q thus disengaging from strike plate 102c and achieving an unlatched configuration for the latch mechanism 102. As depicted in FIGS. 3A (latched configuration) and 3B (unlatched configuration), a biasing mechanism such as spring 102p may be provided to apply a biasing force to some portion of the latch mechanism to urge it to return to the latched configuration. In this embodiment the biasing mechanism 102p applies a force to pivot the latch bolt 102g back into engagement with strike plate 102c. One end of spring 102p presses on the surface of latch bolt 102g while the other end is end in place against the bracket that supports the latch bolt 102g. Unlatching the bolt compresses the spring causing it to apply a force on the latch bolt to return it to the latched position.

In some embodiments a second biasing mechanism may be provided to apply a force to the latch actuator bars 102k and 102l to urge them to return to the latched position when a user releases the actuator handles 102a or 102b. The mechanism 102 may include a stop feature on one or both actuator bars to stop them when they return the nominal latched position shown in FIGS. 2A and 3A. In some embodiments this additional biasing mechanism 102m is a spring that is attached by hooks on each end to an aperture in the actuator bars to pull them inwardly toward the centerline of the cargo container 100.

In the depicted embodiment, each latch actuator bar 102k and 102l is divided into left and right members that are connected by a connecting cable 102r. The function of the latch bars 102k and 102l is the same whether they each are a single member or two separate members connected by a cable.

FIGS. 3A and 3B depict a perspective view of a portion of the inventive latch mechanism 102 in latched and unlatched configurations, respectively. In FIG. 3B, actuator bar 102k has translated in the direction of arrow 106a in response to movement of cable 102e in the direction of arrow 106c. As described in more detail below, this translation of actuator bar 102k causes the pivoting of elbow 102o which in turn pivots latch bolt 102g in the direction of arrow 106b.

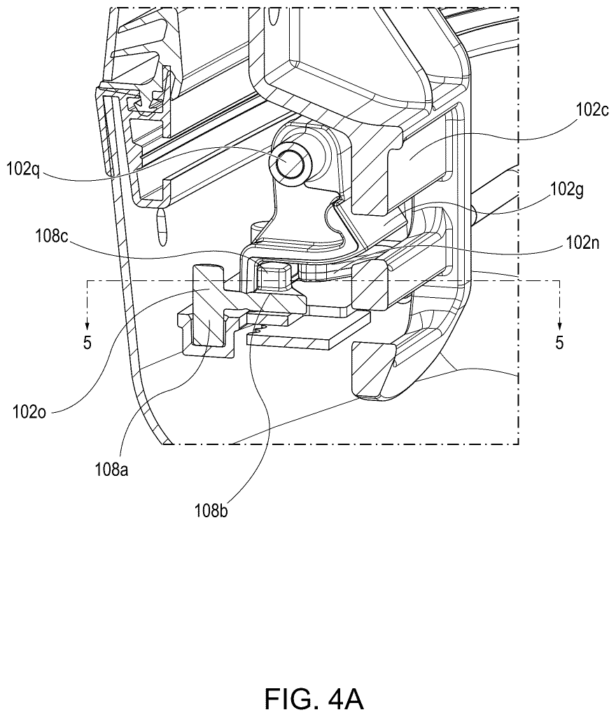

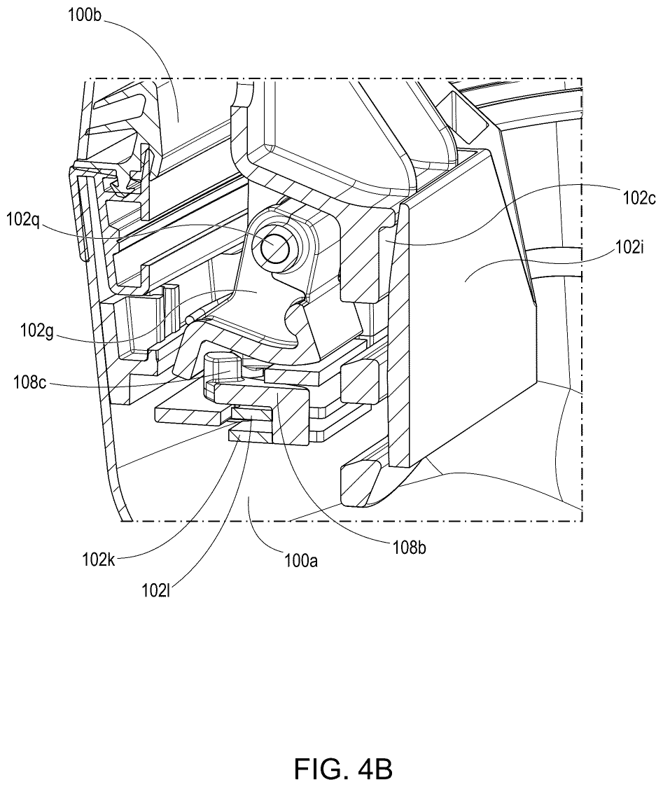

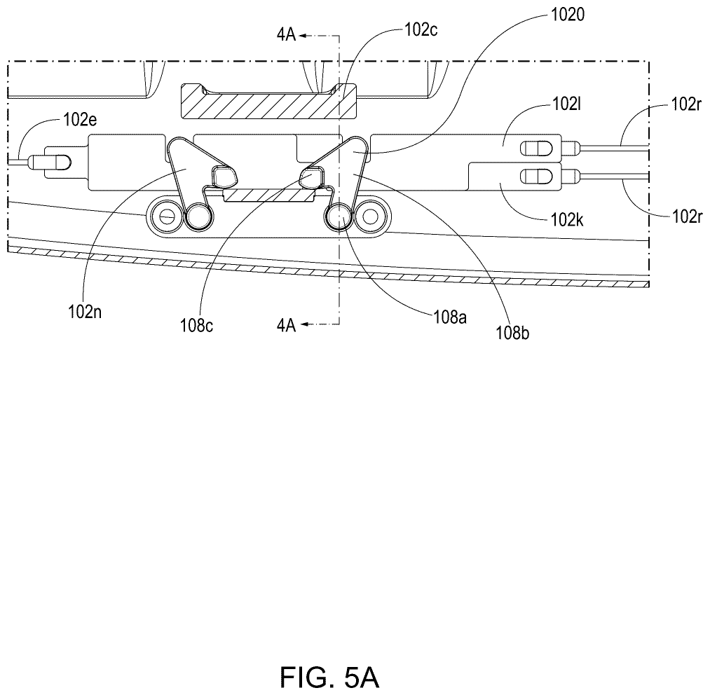

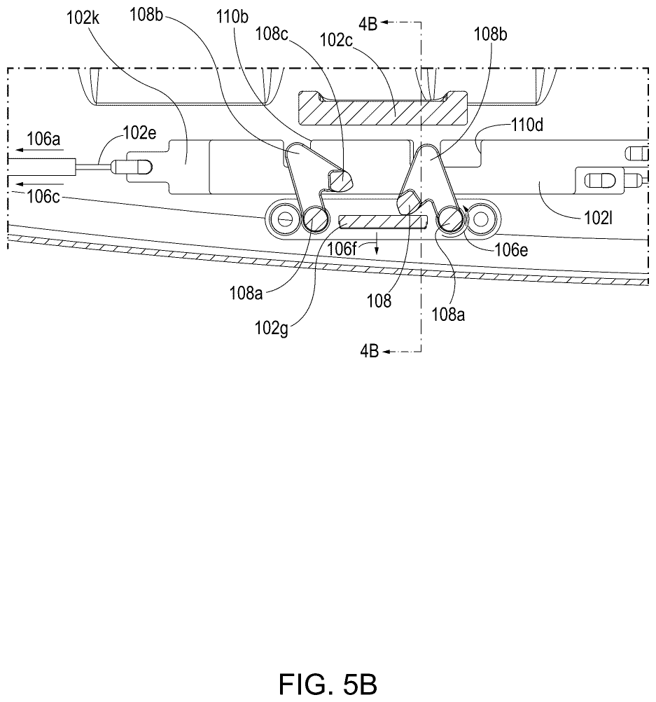

FIG. 4A (latched configuration) and FIG. 4B (unlatched configuration) depict a cross-sectional view of an embodiment of the latch mechanism along axis 4A-4A and 4B-4B, respectively, as those axes are depicted in FIGS. 5A and 5B, respectively. In FIG. 4A a portion of the latch bolt 102g is positioned in contact with a surface of strike plate 102c to secure the cargo container in the closed configuration. In this embodiment a portion of the latch bolt 102g extends into an aperture in the strike plate 102c, though in other embodiments there may be no aperture on the strike plate, but instead surface features or cavities that are engaged by the latch bolt 102g. When a user manipulates the actuator 102a to unlatch the mechanism, in this embodiment the movement of the actuator bar 102k interacts with elbow 108 to pivot the latch bolt 102g around pin 102q to disengage the bolt from the strike plate. In this embodiment the plane of the pivotal motion of the latch bolt 102g is perpendicular to the direction of movement of the actuator bars 102k and 102l. The elbows 108 change the direction of motion of the actuator bars 102k and 102l into a perpendicular movement to pivot the latch bolt 102g as further described below.

In varying embodiments, the two actuator bars 102k and 102l move or slide back and forth in the direction of arrow 106a. In this embodiment each actuator 102a and 102b is attached by cables 102e and 102f, respectively, to actuator bars 102k and 102l respectively. When each actuator is moved by a user, the corresponding actuator bar also moves, thus unlatching all the latches in the mechanism. Actuator bar 102k moves in direction 106a while actuator bar 102l moves in direction 106d. This allows a person to open the cargo container from either side by unlocking and operating only one of the two latch actuators. In other embodiments only a single latch bar may be provided and moved selectively by either latch actuator by a different mechanism than shown in the depicted embodiment.

Each actuator bar 102k and 102l interacts with each latch bolt 102g and 102h via an elbow 108. Each latch bolt 102a and 102h each interacts with two elbows 108 that interact with one of the actuator bars 102k or 102l. In the depicted embodiment, the left elbow 108 that interacts with left latch bolt 102g also interacts with actuator bar 102l while the right elbow 108 interacts with actuator bar 102k. Thus, moving the left actuator 102a pulls cable 102e that translates actuator bar 102k, that pivots right elbow 102o, that pushes left latch bolt 102g, disengaging it from left strike plate 102c. Simultaneously, actuator bar 102k interacts with the right elbow 108 adjacent to right latch bolt 102h and pivots it to disengage it from right strike plate 102d.

FIGS. 5A and 5B depict a top view of the elbows 108 during actuation of the left actuator 102a. The views are along axis 5-5 shown on FIG. 4A. FIG. 5A depicts the elbows in a latched configuration when neither actuator 102a or 102b has been pulled. The elbow pads 108c are not pressing on the adjacent portion of latch bolt 102g so it remains engaged with the strike plate 102c although that portion of the latch bolt is not visible in this cross-section. In the depicted embodiment, when a user moves the actuator 102a to an unlatched configuration the right elbow 108 is pivoted around pivot pin 108a in the direction of arrow 106e by contact with actuator bar 102k. As the right elbow 108 pivots then the elbow pad 108c presses on latch bolt 102g causing it to pivot away from the strike plate 102c in direction 106f. Various apertures or other features in the actuator bars 102k and 102l interact with the elbows 108 as described more fully with respect to later figures.

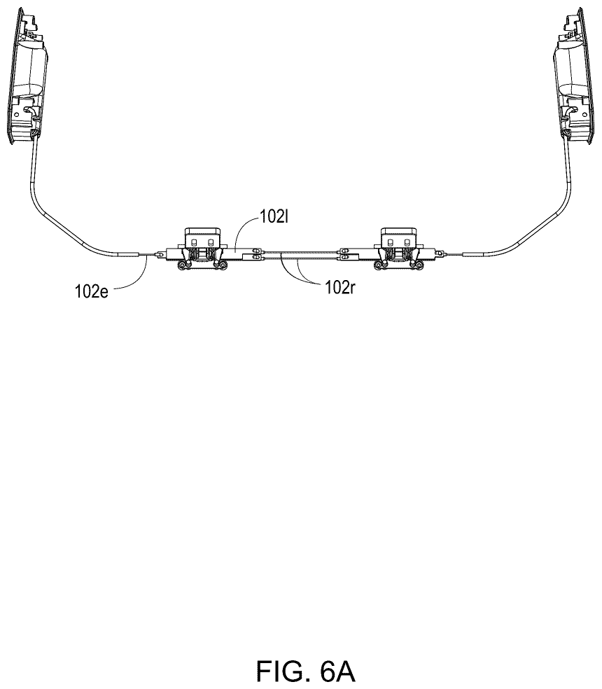

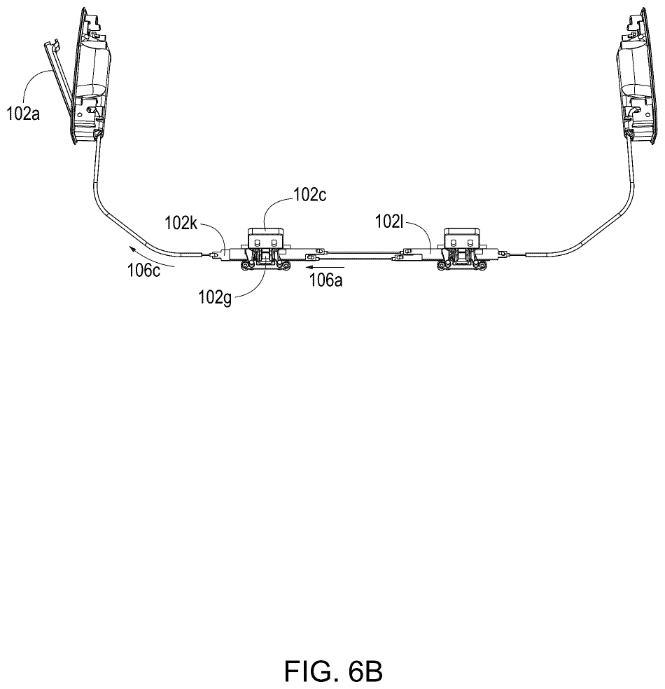

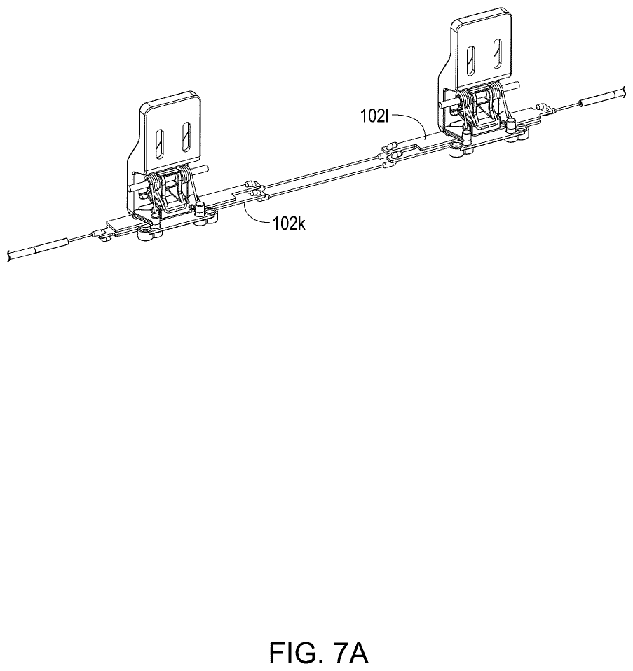

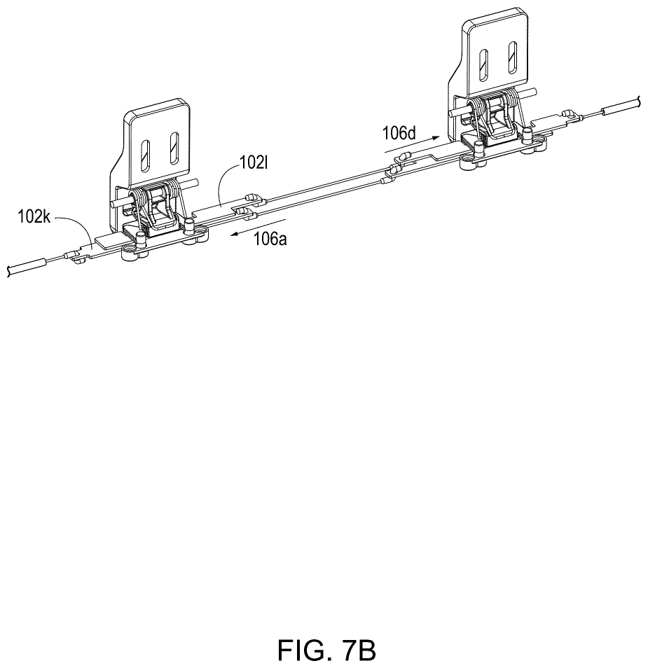

FIGS. 6A and 6B depict top views of the latch mechanism with the shell of the cargo container removed for clarity in latched and unlatched configurations, respectively. The springs 102p apply a centering force in this embodiment to push the elbows and thus the actuator bars back to the latched position when a user is not applying a force to actuator 102a or 102b. Other embodiments may utilize different biasing mechanisms to return the latch mechanism to the latched configuration, including multiple biasing mechanisms attached to different components of the latch mechanism. FIGS. 7A and 7B depict portions of the latch mechanism in perspective views of latched and unlatched configurations, respectively.

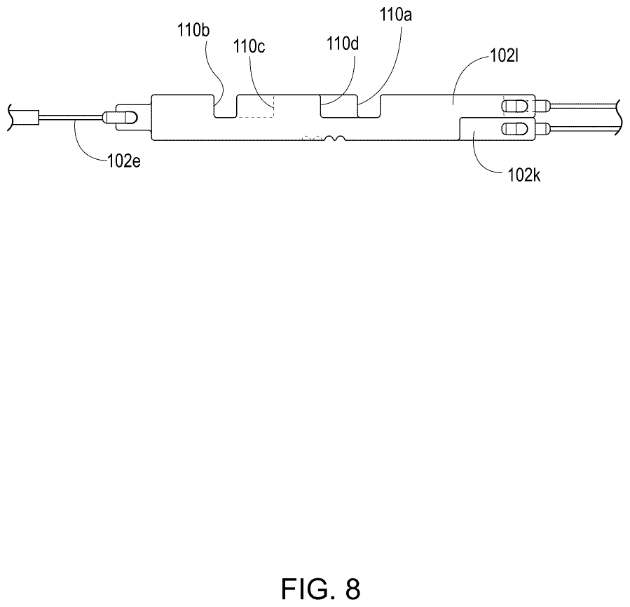

FIG. 8 depicts a portion of the actuator bars 102k and 102l with cable 102e and connecting cables 102r, with most other components of the latch mechanism 102 and cargo container 100 removed for clarity. Actuator bar 102l is depicted with transparency where dotted lines are depicted so that features of actuator bar 102k are visible from the depicted top view. In this embodiment each actuator 102k or 102l has two features, one comprising a follower feature/aperture 110a or 110b on 102k or 102l, respectively. In the depicted embodiment the follower feature engages a follower protrusion 108d on the elbow 108 to move the elbow when the actuator bar moves in response to a user action. The follower features are positioned on the actuator bars so that each actuator bar engages only one of the followers 108d at each latch bolt position. The actuator bar is shaped or configured not to engage the other follower 108d at each latch bolt position. In the depicted embodiment the wide apertures 110c and 110d, which also may be referred to as non-follower apertures, prevent the actuator bars from engaging the other follower 108d at each latch position as they move back and forth.

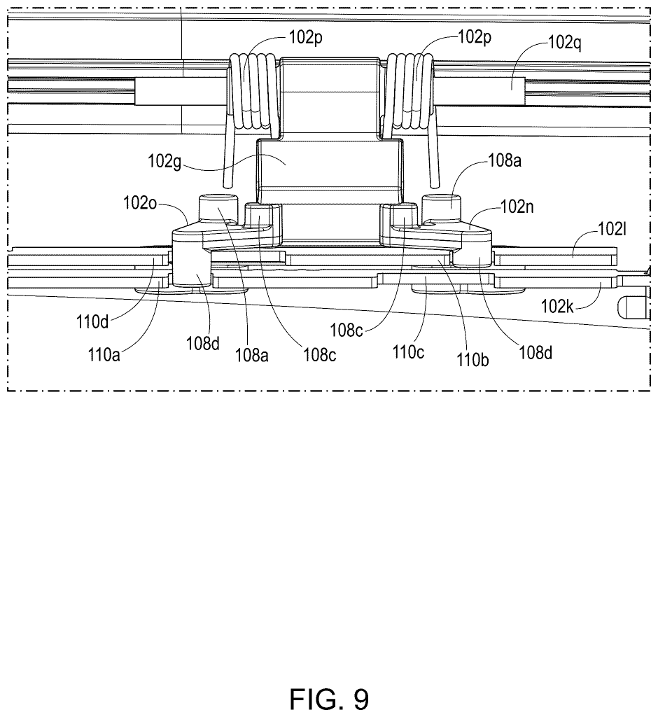

FIG. 9 depicts a detailed view of an embodiment of the actuator bars, the elbows, and the interaction of the followers 108d with the follower apertures 110a/110b. This view is facing toward the rear of the cargo container from a position inside of the closed container. In this embodiment the follower 108d on each elbow 108 extends downwardly into the follower feature on the associated actuator bar. The elbow pads 108c are positioned above the actuator bars and positioned to contact the lower portion of latch bolt 102g when they are pivoted by movement of one of the actuator bars. The wide aperture 110d in actuator bar 102l is shaped so that bar 102l doesn't contact the protrusion 108d as the bar 102l moves back and forth. As either of the actuator bars is translated from side to side one of the followers 108d is moved with it, and the elbow pivots back and forth in response, pushing the elbow pad 108c against the lower portion of latch bolt 102g.

In the depicted embodiment, and other embodiments, the cargo container 100 has an inventive selective unlocking operation. This allows a user to unlock only one of the latch actuators in order to open the cargo container, but doesn't require that both latch actuators be locked for safe use of the cargo container to transport cargo on a moving vehicle. In other cargo containers known in the art that open from both sides, the latches on both sides of the vehicle must be locked for safe operation on the roads. This reduces the functionality of the cargo box because a user may not desire to lock it in temporary transport of some cargo. The configuration of the hinges at the front of the cargo container with latch locations at the back allow for safe operation without locked latches because air pressure forces reduce the pressure on the latches. This latch configuration allows permanent hinges at the same time as double-sided access. Most double-sided access cargo containers have hinges that disconnect to allow that side to open which reduces their safety in an unlocked configuration.

The following item lists A, B, and C are illustrative, but not limiting, of embodiments of the inventive device. Features of the following item lists may constitute features of the other item lists. The reference numbers provided in the item descriptions are for ease of reference to the figures and shall not be construed as limiting their subject matter.
A1. A cargo container for a vehicle, the cargo container (100) comprising a bottom shell (100a), a top shell (100b) movably attached to the bottom shell (100a), a first actuator (102a) and a second actuator (102b) attached to the bottom shell (100a), and a latch mechanism (102) for securing the top shell (100b) in a closed configuration with respect to the bottom shell (100a); and
wherein the latch mechanism (102) comprises a first latch bar (102k) and a second latch bar (102l) slidably mounted on the bottom shell (100a), a first and a second elbow member (102n and 102o) pivotally mounted on the bottom shell (100a), a latch bolt (102g) pivotally mounted on the bottom shell (100a), and a strike plate (102c) attached to the top shell (100a);
wherein the first actuator (102a) is operably connected to the first latch bar (102k) by a first actuator cable (102e);
wherein the second actuator (102b) is operably connected to the second latch bar (102l) by a second actuator cable (102f);
wherein the first latch bar (102l) is configured to pivot the first elbow (102n) upon actuation of the first actuator (102a);
wherein the second latch bar (102b) is configured to pivot the second elbow (102o) upon actuation of the second actuator (102b); and
wherein first and second elbow (102n and 102o) are configured to independently disengage the latch bolt (102g) from the strike plate (102c) upon translation of the first or second latch bar (102k and 102l) by operation of the first or second actuator (102a and 102b) respectively.
A2. The cargo container of A1 wherein the first elbow (102n) comprises a pivot arm (108b) and a follower (108d); and wherein the follower (108d) of the first elbow (102n) engages a follower aperture 110a of the first latch bar (102k).
A3. The cargo container according to any of the preceding A items, wherein the second elbow (102o) comprises a pivot arm (108b) and a follower (108d); and wherein the follower (108d) of the second elbow (102o) engages a follower aperture (110b) of the second latch bar (102l).
A4. The cargo container according to any of the preceding A items, wherein the first and second latch bars (102k and 102l) translate in a plane that is perpendicular to a pivotal axis (108a) of the first elbow (102n) and a pivotal axis (108a) of the second elbow (102o).
A5. The cargo container according to any of the preceding A items, further comprising a biasing mechanism (102p) configured to engage the latch bolt (102g) with the strike plate (102c).

The cargo container according to any of the preceding A items, wherein the biasing mechanism (102p) comprises a torsion spring configured to pivot the latch bolt (102g) toward the strike plate (102c).

The cargo container according to any of the preceding A items, wherein the first latch bar (102k) further comprises a non-following aperture (110c) for receiving the follower (108d) of the second elbow (102o); and the second latch bar (102l) further comprises a non-following aperture (110d) for receiving the follower (108d) of the first elbow (102n).
B1. A cargo container for a vehicle, the cargo container (100) comprising: a bottom shell (100a), a top shell (100b) movably attached to the bottom shell (100a), a first actuator (102a) and a second actuator (102b) attached to the bottom shell (100a), and a latch mechanism (102) for securing the top shell (100b) in a closed configuration with respect to the bottom shell (100a); wherein the latch mechanism (102) comprises a first and a second latch bar (102k and 102l), a first and a second elbow (102n and 102o), and a latch bolt (102g) attached to the bottom shell (100a), and a strike plate (102c) attached to the top shell (100b); wherein first actuator (102a) is configured to translate the first latch bar (102k), and the second actuator (102b) is configured to translate the second latch bar (102l); wherein the first latch bar (102k), upon translation, is configured to pivot the first elbow (102n), and the second latch bar (102l), upon translation, is configured to pivot the second elbow (102o); wherein the first elbow, upon pivoting, is configured to disengage the latch bolt from the strike plate; and wherein the second elbow (102o), upon pivoting, is configured to disengage the latch bolt (102g) from the strike plate (102c).
B2. The cargo container of B1 wherein the first latch bar (102k) comprises a follower aperture (110a) and a non-follower aperture (110c), and the second latch bar (102l) comprises a follower aperture (110b) and a non-follower aperture (110d); and wherein the first elbow (102n) comprises a follower (108d) received by the follower aperture (110a) of the first latch bar (102k) and the non-follower aperture (110d) of the second latch bar (102l); and wherein translation of the follower aperture (110a) of the first latch bar (102k) is configured to translate the follower (108d) of the first elbow (102n); and wherein translation of the non-follower aperture (110d) of the second latch bar (102l) does not translate the follower (108d) of the first elbow (102n).
B3. The cargo container of any of the preceding B items, wherein the second elbow (102o) comprises a follower (108d) received by the follower aperture (110b) of the second latch bar (102l) and the non-follower aperture (110c) of the first latch bar (102k); and wherein the translation of the follower aperture (110b) of the second latch bar (102l) is configured to translate the follower (108d) of the second elbow (102o); and wherein translation of the non-follower aperture (110c) of the first latch bar (102k) does not translate the follower (108d) of the second elbow (102o).
B4. The cargo container of any of the preceding B items, wherein translation of the follower (108d) of the first or second elbow (102n or 102o) pivots that elbow.
B5. The cargo container of any of the preceding B items, wherein the first elbow (102n) and the second elbow (102o) each comprise an arm (108b) configured to contact the latch bolt (102g).
B6. The cargo container of any of the preceding B items, wherein pivotal movement of either the first elbow (102n) or the second elbow (102o) moves the arm (108b) thereof against the latch bolt (102g) to disengage it from the strike plate.
B7. The cargo container of any of the preceding B items, wherein the latch mechanism (102) further comprises a biasing mechanism (102p) to move the latch bolt (102g) to engagement with the strike plate (102c).
C1. A cargo container for a vehicle, the cargo container (100) comprising a bottom shell (100a), a top shell (100b) movably attached to the bottom shell (100a), a first actuator (102a) and a second actuator (102b) attached to the bottom shell (100a), and a latch mechanism (102) attached to the bottom shell (100a) for securing the top shell (100b) in a closed configuration with respect to the bottom shell (100a); wherein the first actuator (102a) and the second actuator (102b) are each configured to disengage the latch mechanism (102) independently whether the other actuator is in a locked configuration or latched configuration.
C2. The cargo container of any of the preceding C items, wherein the latch mechanism (102) comprises a first latch bar (102k) and a second latch bar (102l) slidably mounted on the bottom shell (100a) and operably connected to the first and second actuators (102a and 102b), respectively; wherein actuation of the first or second actuator (102a or 102b) is configured to translate the first or second latch bar (102k or 102l), respectively and independently of the other latch bar; and wherein translation of either of the first or second latch bar (102k or 102l) disengages the latch mechanism (102).
C3. The cargo container of any of the preceding C items, wherein the first latch bar (102k) comprises a follower aperture (110a) and a non-follower aperture (110c), and the second latch bar (102l) comprises a follower aperture (110b) and a non-follower aperture (110d); and the latch mechanism (102) further comprises a first and a second elbow (102n and 102o), both pivotally mounted on the bottom shell (100a); wherein the first elbow (102n) comprises a follower (108d) that is received by the follower aperture (110a) of the first latch bar (102k); and wherein the second elbow (102o) comprises a follower (108d) that is received by the follower aperture (110b) of the second latch bar (102l).
C4. The cargo container of any of the preceding C items, wherein translation of either the first or the second latch bar (102k or 102l) translates the follower aperture (110a or 110b) thereof and moves the follower (108d) of the first or the second elbow (102n or 102o) and pivots the first or second elbow (102n or 102o) to disengage the latch mechanism (102).
C5. The cargo container of any of the preceding C items, wherein the latch mechanism (102) further comprises a latch bolt (102g) pivotally attached to the bottom shell (100a) and configured to engage a strike plate (102c) attached to the top shell (100b); and wherein the first and second elbows (102n and 102o) each further comprise an arm (108b) configured to disengage the latch bolt (102g) from the strike plate (102c).
C6. The cargo container of any of the preceding C items, wherein the latch mechanism (102) further comprises a biasing mechanism (102p) configured to pivot the latch bolt (102g) into engagement with the strike plate (102c).

“Substantially”, “approximately”, or “about” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder. The terms “about” or “substantially” or “approximately” as used herein indicates the value of a given quantity that can vary based on a particular technology. Based on the particular technology, the term “about” or “substantially” or “approximately” can indicate a value of a given quantity that varies within, for example, 1-15% of the value (e.g., ±1%, ±2%, ±5%, ±10%, or ±15% of the value).

“Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

1. A cargo container for a vehicle, the cargo container comprising:
a lid pivotally attached to a base on no more than one side of the base;
a latch configured to releasably secure the lid in a closed position;
a first handle on a first side of the base;
a second handle on a second side of the base;
wherein the first and second handles are configured to independently disengage the latch to release the lid from the closed position.

2. The cargo container of claim 1, further comprising a first lock configured to secure the first handle, and a second lock configured to secure the second handle.

3. The cargo container of claim 1, wherein when the cargo container is disposed on a roof of a vehicle, the first handle is adjacent to a driver-side of the vehicle and the second handle is adjacent to a passenger side of the vehicle.

4. The cargo container of claim 1, wherein the first handle is operably attached to the latch by a first control cable; and the second handle is operably attached to the latch by a second control cable.

5. The cargo container of claim 1, wherein the first handle is configured to actuate a first pivotal member to disengage the latch; and wherein the second handle is configured to actuate a second pivotal member to disengage the latch.

6. The cargo container of claim 1, wherein the lid is pivotally attached to the base on a front edge thereof.

7. A cargo container for a vehicle, the cargo container comprising:
a lid pivotally attached to a base along a single pivot axis;
a latch mechanism configured to releasably secure the lid to the base in a closed position, the latch mechanism comprising a first release component and a second release component, each configured to independently disengage the latch mechanism;
a first handle on a first side of the base configured to actuate the first release component;
a second handle on a second side of the base configured to actuate the second release component.

8. The cargo container of claim 7, wherein the first and second release components pivot independently of each other to disengage the latch mechanism.

9. The cargo container of claim 7, wherein the first and second release components translate independently of each other to disengage the latch mechanism.

10. The cargo container of claim 7, wherein the latch mechanism further comprises a strike plate and a bolt component configured to engage the strike plate, wherein the bolt component pivots in the latch mechanism between engaged and disengaged positions; and
wherein each of the first and second release components pivot to move the bolt component to the disengaged position.

11. The cargo container of claim 10, wherein the first and second release components comprise a protrusion configured to push the bolt component to the disengaged position; and
wherein the latch mechanism further comprises a biasing mechanism configured to urge the bolt component toward the engaged position

12. The cargo container of claim 10 wherein the strike plate is mounted on the lid and the bolt component is mounted on the base.

13. The cargo container of claim 10 wherein the strike plate comprises an aperture for receiving the bolt component in the engaged position.

14. The cargo container of claim 10 wherein the first and second release components pivot within the latch mechanism around pivot axes that are perpendicular to a pivot axis of the bolt component.

15. The cargo container of claim 7 wherein the single pivot axis is at a front edge of the base.

16. A cargo container for a vehicle, the cargo container comprising:
a base component for attachment to the vehicle;
a lid component pivotally attached to the base component and moveable between a closed position and an open position;
a latch mechanism comprising a strike plate, a bolt component, a first release component, and a second release component;
wherein the first release component and the second release component are configured to independently move the bolt component between an engaged position and a disengaged position with respect to the strike plate; and
a first handle attached to a first side of the cargo container and configured to move the first release component;
a second handle attached to a second side of the cargo container and configured to move the second release component;
wherein the lid component is pivotally attached to the base component along a single pivot axis.

17. The cargo container of claim 16, wherein the first release component and the second release component are pivotally attached to the latch mechanism.

18. The cargo container of claim 17, wherein the bolt component pivots between the engaged position and the disengaged position.

19. The cargo container of claim 16, further comprising a second latch mechanism comprising a strike plate, a bolt component, a first release component, and a second release component;
wherein the first and second handles are configured to independently move the bolt component of the second latch mechanism between the engaged and disengaged position simultaneously with the movement of the bolt component of the latch mechanism.

20. The cargo container of claim 17, wherein the release component comprises a protrusion configured to push the bolt component toward the disengaged position; and
wherein the latch mechanism further comprises a biasing mechanism configured to urge the bolt component toward the engaged position.
